(19) United States
(12) Patent Application Publication
(10) Pub. No.: US 2023/0418270 A1
(43) Pub. Date: Dec. 28, 2023

(54) AREA MANAGEMENT SYSTEM, AREA MANAGEMENT METHOD, AND STORAGE MEDIUM

(71) Applicant: TOYOTA JIDOSHA KABUSHIKI KAISHA, Toyota-shi (JP)

(72) Inventors: Hisataka YUASA, Toyota-shi (JP); Kazuhiro SHINTANI, Toyokawa-shi (JP); Shintaro YOSHIZAWA, Nagoya-shi (JP); Masayoshi TSUCHINAGA, Nisshin-shi (JP); Yuto MORI, Toyota-shi (JP); Takayuki KANAI, Toyota-shi (JP)

(73) Assignee: TOYOTA JIDOSHA KABUSHIKI KAISHA, Toyota-shi (JP)

(21) Appl. No.: 18/133,046

(22) Filed: Apr. 11, 2023

(30) Foreign Application Priority Data
Jun. 27, 2022 (JP) 2022-102763

(51) Int. Cl. G05B 19/418

(52) U.S. Cl. CPC G05B 19/41865

(57) ABSTRACT

An area management system includes an acquisition unit configured to acquire information on a mobile history of at least one mobile object that moves in a management target area, a statistical processing unit configured to generate a distribution of existence probability of the at least one mobile object in a management target area by performing statistical processing on information on a mobile history of the at least one mobile object, and an area definition unit configured to define a predetermined area included in the management target area together with an area attribute of the predetermined area, based on the distribution of existence probability of the at least one mobile object in the management target area.

### CROSS-REFERENCE TO RELATED APPLICATION

This application claims priority to Japanese Patent Application No. 2022-102763 filed on Jun. 27, 2022, incorporated herein by reference in its entirety.

### BACKGROUND

### 1. Technical Field

The disclosure relates to an area management system, an area management method, and a storage medium.

### 2. Description of Related Art

In recent years, it is desired to accurately monitor the situations of mobile objects, including work robots and workers, in a predetermined area, such as a factory.

An area situation identification system described in Japanese Unexamined Patent Application Publication No. 2020-113875 (JP 2020-113875 A) includes an image capture device that captures the image of a predetermined area, a location calculation unit that calculates the location of a person or object from the image of the area, captured by the image capture device, a transmission unit that transmits the location calculated by the location calculation unit as location information, a receiving unit that receives the location information transmitted by the transmission unit, and an image synthesizing unit that synthesizes a symbol representing the person or object with the image of the area, captured in advance, based on the location information received by the receiving unit. Thus, the area situation identification system easily grasps the environment of the predetermined area and reduces communication traffic.

### SUMMARY

However, with the system described in JP 2020-113875 A, the symbol representing the location of the person or object is just displayed together with the area image, so a mobile area in which the mobile object moves, a work area in which the mobile object does work, and other areas in the predetermined area are not defined. In other words, with this system, a user him or herself needs to determine the mobile area, the work area, and other areas. Therefore, with this system, an error tends to occur in determining the mobile area and the work area. As a result, with this system, it is not possible to accurately manage the predetermined area. If such a system is applied to a system that automatically monitors a mobile object, it is not possible to accurately monitor the mobile object.

The disclosure provides an area management system, an area management method, and a storage medium capable of accurately managing a management target area.

An area management system according to the disclosure includes an acquisition unit configured to acquire information on a mobile history of at least one mobile object that moves in a management target area, a statistical processing unit configured to generate a distribution of existence probability of the at least one mobile object in the management target area by performing statistical processing on the information on the mobile history of the at least one mobile object, and an area definition unit configured to define a predetermined area included in the management target area together with an area attribute of the predetermined area, based on the distribution of existence probability of the at least one mobile object in the management target area. The area management system automatically defines a mobile area in which a mobile object, such as a person, a vehicle, and a work robot, moves, a work area in which work is performed by the mobile object, and the like in a management target area, thus eliminating the need of a user him or herself to determine the mobile area, the work area, and the like, which tends to have an error. Thus, the area management system is capable of accurately managing a management target area. When the above system is applied to a system that automatically monitors a mobile object, the system is capable of accurately monitoring the mobile object.

The area definition unit may be configured to define an area in which a distribution of standard deviation smaller than a first predetermined deviation is continuous over a first predetermined distance or longer in the distribution of existence probability, as a mobile area in which a mobile object with a predetermined moving route, of the at least one mobile object, moves.

The mobile object with a predetermined moving route may include an automatic guided vehicle (AGV).

The area definition unit may be configured to define an area in which a distribution of standard deviation larger than a second predetermined deviation is continuous over a second predetermined distance or longer in the distribution of existence probability, as a mobile area in which a mobile object without a predetermined moving route, of the at least one mobile object, moves.

The mobile objects without a predetermined moving route may include a person and an autonomous mobile robot (AMR).

The area definition unit may be configured to define an area partially or entirely surrounded by points at which continuity of the distribution of existence probability is interrupted, as a work area in which a predetermined work is conducted by the at least one mobile object.

The area management system may further include a database in which a plurality of types of the distribution of existence probability and a plurality of area attributes are stored in association with each other. The area definition unit may be configured to define at least part of the distribution of existence probability, generated by the statistical processing unit, as the predetermined area and extract, from the database, the area attribute associated with the distribution of existence probability of the type corresponding to the at least part of the distribution of existence probability, generated by the statistical processing unit. The area definition unit may be configured to define the extracted area attribute as an area attribute of the at least part of the distribution of existence probability, generated by the statistical processing unit.

The area definition unit may be configured to be capable of identifying a location at which, in the predetermined area defined as a mobile area in which the at least one mobile object moves, an existence probability at a scheduled existence location of the at least one mobile object after a lapse of a predetermined period of time is lower than or equal to a predetermined probability.

An area management method according to the disclosure includes acquiring information on a mobile history of at least one mobile object that moves in a management target area, generating a distribution of existence probability of the at least one mobile object in the management target area by performing statistical processing on the acquired information on the mobile history of the at least one mobile object, and defining a predetermined area included in the management target area together with an area attribute of the predetermined area, based on the generated distribution of existence probability of the at least one mobile object in the management target area. The area management method automatically defines a mobile area in which a mobile object, such as a person, a vehicle, and a work robot, moves, a work area in which work is performed by the mobile object, and the like in a management target area, thus eliminating the need of a user him or herself to determine the mobile area, the work area, and the like, which tends to have an error. Thus, the area management method is capable of accurately managing a management target area. When the above method is applied to a system that automatically monitors a mobile object, the system is capable of accurately monitoring the mobile object.

A storage medium according to the disclosure stores an area management program that causes a computer to execute functions. The functions include acquiring information on a mobile history of at least one mobile object that moves in a management target area, generating a distribution of existence probability of the at least one mobile object in the management target area by performing statistical processing on the acquired information on the mobile history of the at least one mobile object, and defining a predetermined area included in the management target area together with an area attribute of the predetermined area, based on the generated distribution of the existence probability of the at least one mobile object in the management target area. The area management program automatically defines a mobile area in which a mobile object, such as a person, a vehicle, and a work robot, moves, a work area in which work is performed by the mobile object, and the like in a management target area, thus eliminating the need of a user him or herself to determine the mobile area, the work area, and the like, which tends to have an error. Thus, the area management program is capable of accurately managing a management target area. When the above program is applied to a system that automatically monitors a mobile object, the system is capable of accurately monitoring the mobile object.

According to the disclosure, it is possible to provide an area management system, an area management method, and a storage medium capable of accurately managing a management target area.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram that shows an example of the configuration of an area management system according to a first embodiment;

FIG. 2 is a schematic perspective view that shows a case of application of the area management system shown in FIG. 1;

FIG. 3 is a flowchart that shows the operations of the area management system shown in FIG. 1;

FIG. 4 is a schematic plan view that shows a distribution of existence probability of a mobile object in a management target area;

FIG. 5 is a schematic plan view that shows a distribution of existence probability of a mobile object in a management target area;

FIG. 6 is a schematic plan view that shows an area defined based on a distribution of existence probability of a mobile object in a management target area and an attribute of the area; and

FIG. 7 is a view for illustrating a method of defining an area susceptible to a disturbance from a distribution of existence probability of a mobile object in a management target area.

### DETAILED DESCRIPTION OF EMBODIMENTS

Hereinafter, an embodiment of the disclosure will be described; however, the disclosure is not intended to be limited to the embodiment. All the components of the embodiment are not always indispensable. For clear illustration, the following description and drawings are omitted or simplified as needed. In the drawings, like reference numerals denote like elements, and the description will not be repeated where appropriate.

### FIRST EMBODIMENT

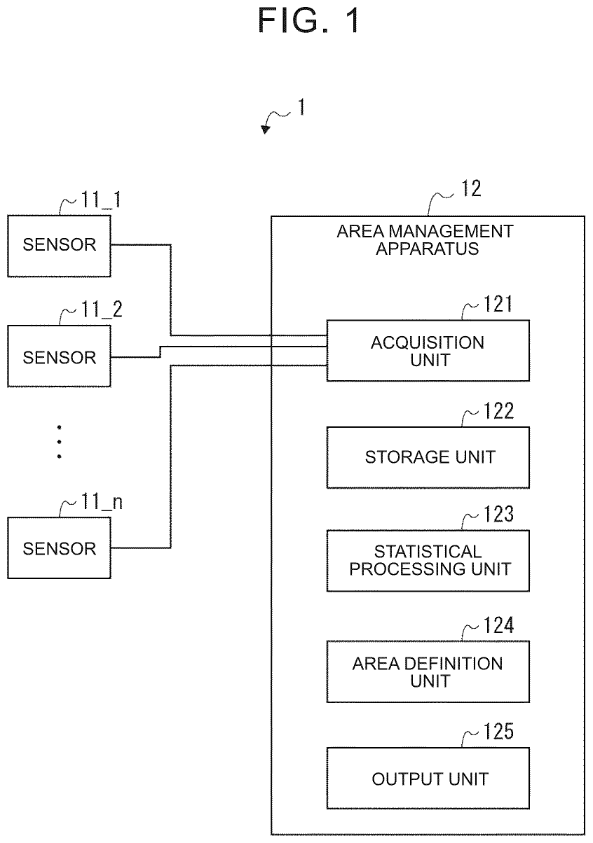

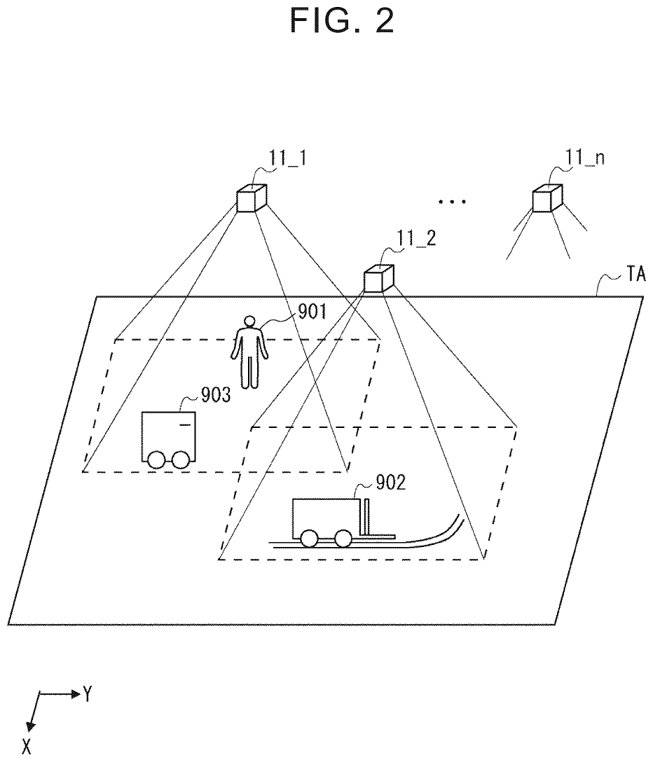

FIG. 1 is a block diagram that shows an example of the configuration of an area management system 1 according to a first embodiment. FIG. 2 is a schematic perspective view that shows a case of application of the area management system 1. The area management system 1 according to the present embodiment automatically defines a mobile area in which a mobile object, such as a person, a vehicle, and a work robot, moves, a work area in which work is performed by the mobile object, and the like in a management target area, thus eliminating the need of a user him or herself to determine the moving area, the work area, and the like, which tends to have an error. Thus, the area management system 1 according to the present embodiment is capable of accurately managing a management target area. When the above system is applied to a system that automatically monitors a mobile object, the system is capable of accurately monitoring the mobile object. Hereinafter, this will be specifically described.

The area management system 1 is applied to, for example, a plant PL1, such as a factory, and includes n (n is an integer greater than or equal to one) sensors 11_1, . . . , 11_n, and an area management apparatus 12. The area management apparatus 12 may also be regarded as the area management system 1.

The sensors 11_1, . . . , 11_n are installed on a ceiling or the like of the plant PL1. The sensors 11_1, . . . , 11_n detect mobile objects M including a worker 901, a first mobile object 902, and a second mobile object 903, present in a management target area TA in the plant PL1. In the example of FIG. 2, the worker 901, the first mobile object 902, and the second mobile object 903 are present in the management target area TA as the mobile objects M; however, the configuration is not limited thereto. One or more workers 901, one or more first mobile objects 902, and one or more second mobile objects 903 may be present in the management target area TA. One or some of the sensors 11_1, . . . , 11_n may be attached to any one or some of the mobile objects M.

The worker 901 is a person instructed to conduct predetermined work in the management target area TA in the plant PL1. The mobile objects M include not only the worker 901 but also a passerby and the like that pass in the plant PL1.

The first mobile object 902 is a mobile object that runs along a predetermined moving route. The first mobile object 902 is, for example, a vehicle that runs on a rail, an automatic guided vehicle (AGV) configured to automatically run along a predetermined moving route, or the like.

The second mobile object 903 is a mobile object that automatically determines a moving route in accordance with an ambient environment, such as an obstacle, and runs along the moving route. The second mobile object 903 is, for example, an autonomous mobile robot (AMR) configured to automatically perform predetermined work. The second mobile object 903 also includes a vehicle or the like that a worker operates.

The sensors 11_1, . . . , 11_n are, for example, cameras and installed so as to be capable of capturing the entire image of the management target area TA in the plant PL1. Each of the sensors 11_1, . . . , 11_n is not limited to a camera and may be a sensor of a selected type capable of detecting a mobile object M, such as a distance measuring sensor.

The area management apparatus 12 is an apparatus that automatically defines a mobile area in which a mobile object M moves, a work area in which work is performed by the mobile object M, and the like in the management target area TA in the plant PL1 to manage the management target area TA in the plant PL1.

Specifically, the area management apparatus 12 includes at least an acquisition unit 121, a storage unit 122, a statistical processing unit 123, an area definition unit 124, and an output unit 125.

The acquisition unit 121 acquires information on a mobile history of each of the mobile objects M, detected by the sensors 11_1, . . . , 11_n. Specifically, the acquisition unit 121 periodically acquires location information of each of the mobile objects M, detected by the sensors 11_1, . . . , 11_n. The location information of each of the mobile objects M, periodically acquired by the acquisition unit 121, is stored in the storage unit 122 as information on the mobile history of each of the mobile objects M. The storage unit 122 may be provided outside the area management apparatus 12 as a storage device.

The statistical processing unit 123 extracts features of at least one mobile object M by executing statistical processing on the information on the mobile history of the at least one mobile object M, stored in the storage unit 122, and expresses the extracted features on a spatial map. In other words, the statistical processing unit 123 generates a distribution of existence probability of at least one mobile object M in the management target area TA by executing statistical processing on the information on the mobile history of the at least one mobile object M, stored in the storage unit 122.

The area definition unit 124 defines a predetermined area included in the management target area TA together with the attribute of the predetermined area based on the distribution of existence probability of the at least one mobile object M in the management target area TA, generated by the statistical processing unit 123. The attribute of the predetermined area indicates that the predetermined area is a mobile area, a work area, or the like. For example, the area definition unit 124 defines a mobile area, a work area, and the like, included in the management target area TA based on the distribution of existence probability of the at least one mobile object M in the management target area TA, generated by the statistical processing unit 123.

The output unit 125 outputs information on the mobile area, the work area, and the like defined by the area definition unit 124. For example, the output unit 125 causes the management target area TA to be displayed on a monitor in a desired display format together with the mobile area, the work area, and the like, defined on the management target area TA.

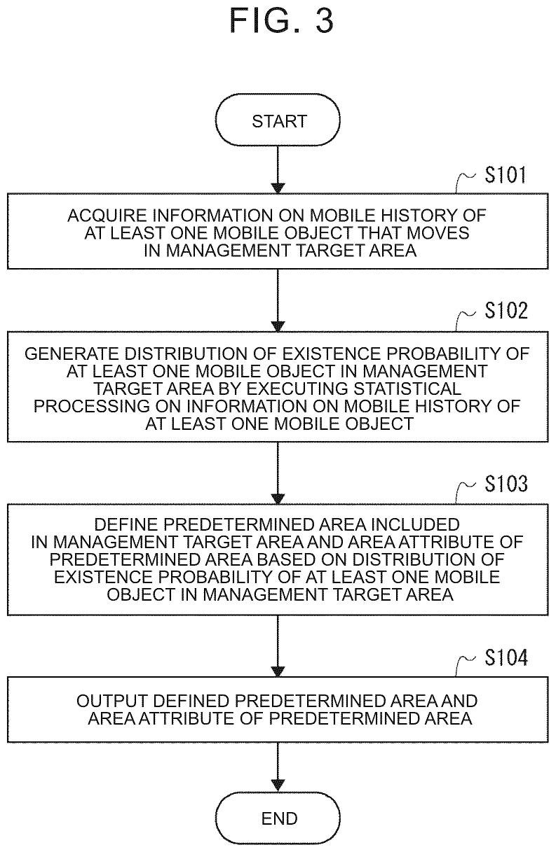

Subsequently, the operations of the area management system 1 will be described with reference to FIG. 3 in addition to FIG. 1 and FIG. 2. FIG. 3 is a flowchart that shows the operations of the area management system 1.

In the area management system 1, the area management apparatus 12 acquires information on the mobile history of each of the mobile objects M, detected by the sensors 11_1, . . . , 11_n installed in the plant PL1 (step S101). Specifically, the area management apparatus 12 periodically acquires the location information of each of the mobile objects M, detected by the sensors 11_1 to 11_n, and stores the location information as information on the mobile history of each of the mobile objects M. In the example of FIG. 2, the area management apparatus 12 acquires information on the mobile history of each of the worker 901, the first mobile object 902, and the second mobile object 903.

After that, the area management apparatus 12 generates a distribution of existence probability of at least one mobile object M in the management target area TA by executing statistical processing on the information on the mobile history of the at least one mobile object M (step S102). In the example of FIG. 2, the area management apparatus 12 generates a distribution of existence probability of each of the worker 901, the first mobile object 902, and the second mobile object 903 in the management target area TA by executing statistical processing on the information on the mobile history of each of the worker 901, the first mobile object 902, and the second mobile object 903.

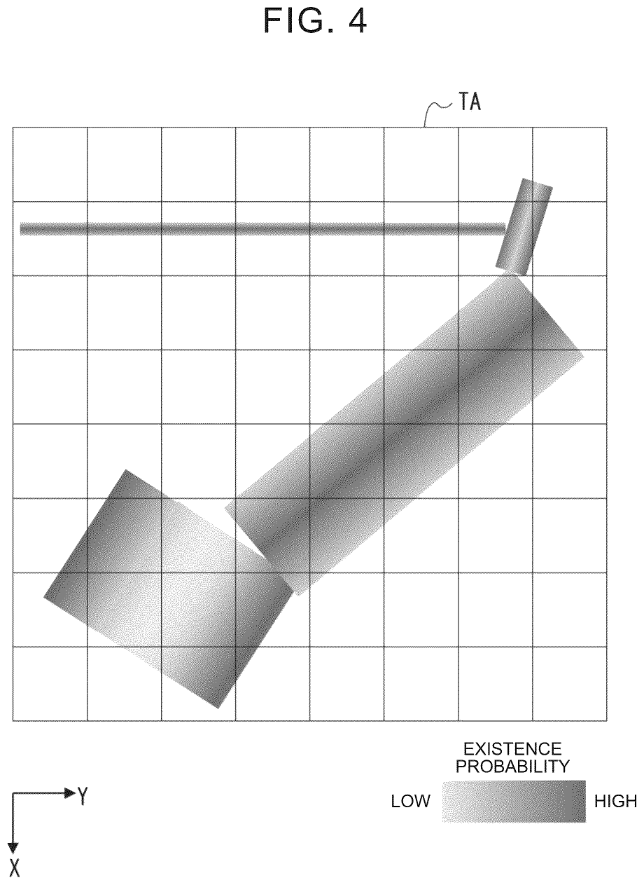

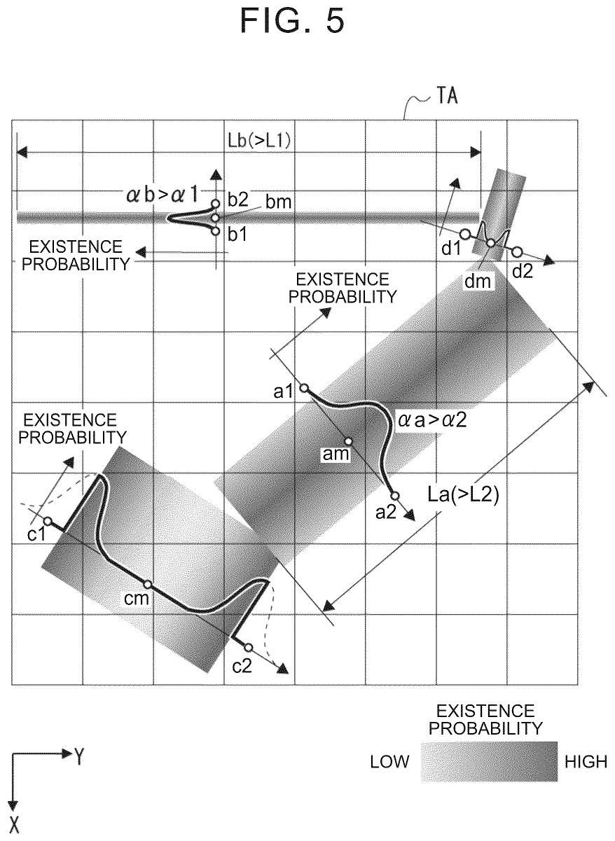

FIG. 4 and FIG. 5 are schematic plan views that show a distribution of existence probability of the mobile object M in the management target area TA. FIG. 5 partially shows a graph that shows a distribution of existence probability of the mobile object M in the management target area TA. In the example of FIG. 4 and FIG. 5, in the management target area TA, the existence probability of the mobile object M increases as the area gets closer to black color, and the existence probability of the mobile object M decreases as the area gets closer to white color.

As shown in FIG. 5, for example, the existence probability of a mobile object M in a line segment connecting locations a1, a2 of the management target area TA is lowest at the location a1 and the location a2, gradually increases from the location a1 and the location a2 toward a middle point am between the locations a1, a2, and is highest at the middle point am. A standard deviation αa of the distribution of existence probability is larger than a predetermined second predetermined deviation α2 (that is, variations in the distribution of the existence probability are relatively large). The distribution of the standard deviation αa larger than the second predetermined deviation α2 is continuous over a distance La longer than or equal to a second predetermined distance L2.

The existence probability of a mobile object M in a line segment connecting locations b1, b2 of the management target area TA is lowest at the location b1 and the location b2, gradually increases from the location b1 and the location b2 toward a middle point bm between the locations b1, b2, and is highest at the middle point bm. A standard deviation αb of the distribution of the existence probability is smaller than a predetermined first predetermined deviation α1 (that is, variations in the distribution of existence probability are relatively small). The distribution of the standard deviation αb smaller than the first predetermined deviation α1 is continuous over a distance Lb longer than or equal to a first predetermined distance L1.

The existence probability of a mobile object M in a line segment connecting locations c1, c2 in the management target area TA is the highest at the location c1 and the location c2, gradually decreases from the location c1 and the location c2 toward a middle point cm between the locations c1, c2, and is the lowest at the middle point cm. At each of the locations c1, c2, the continuity of the distribution of existence probability of a mobile object M is interrupted. Similarly, the existence probability of a mobile object M in a line segment connecting locations d1, d2 in the management target area TA is highest at the location d1 and the location d2, gradually decreases from the location d1 and the location d2 toward a middle point dm between the locations d1, d2, and is lowest at the middle point dm. At each of the locations d1, d2, the continuity of the distribution of existence probability of a mobile object M is interrupted.

After that, the area management apparatus 12 defines a predetermined area included in the management target area TA together with the attribute of the predetermined area based on the distribution of existence probability of the at least one mobile object M in the management target area TA (step S103).

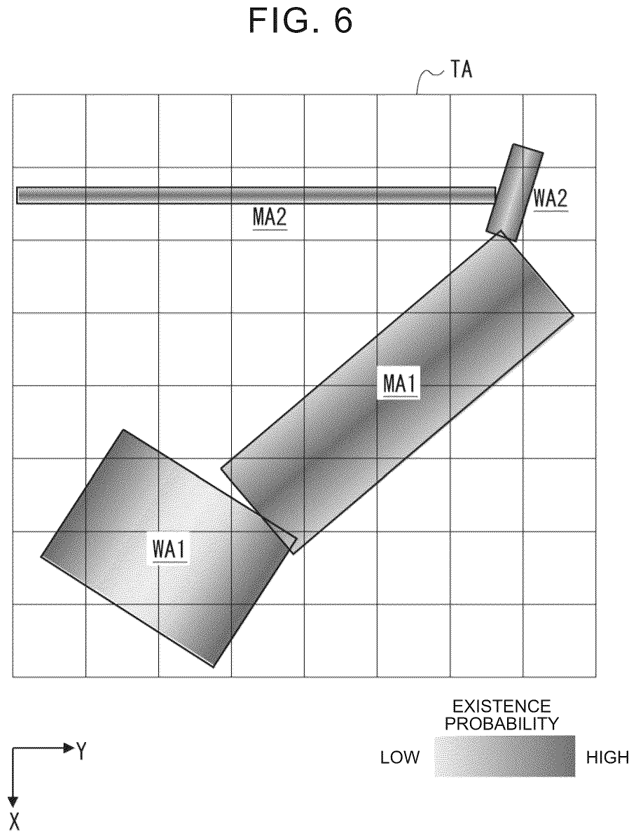

FIG. 6 is a schematic plan view that shows an area defined based on the distribution of existence probability of a mobile object M in the management target area TA and the attribute of the area. The management target area TA shown in FIG. 6 corresponds to the management target area TA shown in FIG. 4 and FIG. 5.

As shown in FIG. 5 and FIG. 6, initially, the area management apparatus 12 defines an area MA1 in which the distribution of the standard deviation αa larger than the second predetermined deviation α2 is continuous over the distance La longer than or equal to the second predetermined distance L2 in the distribution of existence probability of a mobile object M in the management target area TA, as a mobile area in which a mobile object without a predetermined moving route moves. In other words, the area management apparatus 12 defines the area MA1 in which an area with relatively large variations of the distribution of existence probability of a mobile object M is continuous as a mobile area in which a mobile object without a predetermined moving route moves. A mobile object without a predetermined moving route is, for example, the second mobile object 903, including an autonomous mobile robot configured to automatically conduct predetermined work, or the worker 901.

The area management apparatus 12 defines an area MA2 in which the distribution of the standard deviation αb smaller than the first predetermined deviation α1 is continuous over the distance Lb longer than or equal to the first predetermined distance L1 in the distribution of existence probability of a mobile object M in the management target area TA, as a mobile area in which a mobile object with a predetermined moving route moves. In other words, the area management apparatus 12 defines the area MA2 in which an area with relatively small variations of the distribution of existence probability of a mobile object M is continuous as a mobile area in which a mobile object with a predetermined moving route moves. A mobile object with a predetermined moving route is, for example, the first mobile object 902, including a vehicle that runs on a rail and a vehicle such as an AGV configured to automatically run along a predetermined moving route.

In addition, the area management apparatus 12 defines areas WA1, WA2 partially or entirely surrounded by points at which the continuity of the distribution is interrupted in the distribution of existence probability of the mobile object M in the management target area TA, as work areas in which predetermined work is conducted by the mobile object M. In other words, the area management apparatus 12 defines the areas WA1, WA2 partially or entirely surrounded at a specific location at which a mobile object M stops in order to perform the predetermined work as work areas in which the predetermined work is conducted by the mobile object M.

After that, the area management apparatus 12 outputs information on the defined mobile area, work area, and the like (step S104). For example, the area management apparatus 12 causes the management target area TA to be displayed on a monitor in a desired display format together with the mobile area, the work area, and the like, defined on the management target area TA.

In this way, the area management system 1 according to the present embodiment automatically defines a mobile area in which a mobile object M, such as a person, a vehicle, and a work robot, moves, a work area in which work is performed by the mobile object M, and the like in a management target area TA, thus eliminating the need of a user him or herself to determine the moving area, the work area, and the like, which tends to have an error. Thus, the area management system 1 according to the present embodiment is capable of accurately managing a management target area. When the above system is applied to a system that automatically monitors a mobile object M, the system is capable of accurately monitoring the mobile object M.

The area management system 1 may further include a database in which a plurality of types of the distribution of existence probability and a plurality of area attributes are stored in association with each other. In this case, the area definition unit 124 provided in the area management apparatus 12 initially extracts from the database the area attribute associated with the distribution of existence probability of a type corresponding to at least part of the distribution of existence probability, generated by the statistical processing unit 123. The area definition unit 124 defines a mobile area, a work area, and the like on the “at least part of the distribution of existence probability” generated by the statistical processing unit 123. Not only a work area and a mobile area but also various types of area attributes may be entered in the database.

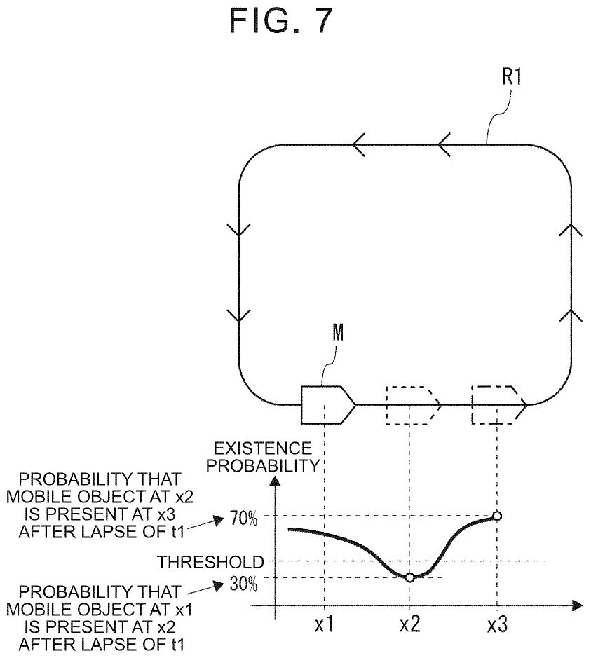

In the area management system 1, the area management apparatus 12 may have the function of predicting the existence probability at a scheduled existence location after a lapse of a predetermined period of time t1, of a mobile object M with a predetermined moving route R1 by using Gaussian process to identify a location at which the existence probability of the mobile object M is lower than or equal to a threshold (predetermined probability). As shown in FIG. 7, the existence probability at a location X2 that is a scheduled existence location after a lapse of the predetermined period of time t1, of the mobile object M present at the location X1, indicates 30% that is lower than or equal to the threshold, and the existence probability at a location X3 that is a scheduled existence location after a lapse of the predetermined period of time t1, of the mobile object M present at the location X2, indicates 70% that exceeds the threshold. Here, it is presumable that there is a factor (disturbance) that temporarily interferes with movement of a mobile object M, for example, many passersby come and go, at the location X2 at which the existence probability indicates 30%. The area management apparatus 12 may identify such a location and, where necessary, output the identified information. Thus, the area management system 1 further accurately manages the management target area.

The disclosure is not limited to the above-described embodiment and may be modified as needed without departing from the scope of the disclosure.

The disclosure allows part or all of the processes of the area management apparatus 12 to be implemented by causing a central processing unit (CPU) to run a computer program.

The above program includes a command set (or software code) for causing a computer to execute one or more functions described in the embodiment when the program is loaded onto the computer. The program may be stored in a non-transitory computer-readable medium or tangible storage medium. Nonrestrictive examples of the computer-readable medium or tangible storage medium include memory technologies, such as a random-access memory (RAM), a read-only memory (ROM), a flash memory, a solid-state drive (SSD), and others, optical disk storages, such as a CD-ROM, a digital versatile disc (DVD), a Blu-ray (registered trademark) disc, and others, and magnetic storage devices, such as a magnetic cassette, a magnetic tape, a magnetic disk storage, and others. The program may be transmitted on a transitory computer-readable medium or communication medium. Nonrestrictive examples of the temporary computer-readable medium or communication medium include an electrical, optical, acoustic, or other-type propagation signals.

What is claimed is:

1. An area management system comprising:
an acquisition unit configured to acquire information on a mobile history of at least one mobile object that moves in a management target area;
a statistical processing unit configured to generate a distribution of existence probability of the at least one mobile object in the management target area by performing statistical processing on the information on the mobile history of the at least one mobile object; and
an area definition unit configured to define a predetermined area included in the management target area together with an area attribute of the predetermined area, based on the distribution of existence probability of the at least one mobile object in the management target area.

2. The area management system according to claim 1, wherein the area definition unit is configured to define an area in which a distribution of standard deviation smaller than a first predetermined deviation is continuous over a first predetermined distance or longer in the distribution of existence probability, as a mobile area in which a mobile object with a predetermined moving route, of the at least one mobile object, moves.

3. The area management system according to claim 2, wherein the mobile object with the predetermined moving route includes an automatic guided vehicle (AGV).

4. The area management system according to claim 1, wherein the area definition unit is configured to define an area in which a distribution of standard deviation larger than a second predetermined deviation is continuous over a second predetermined distance or longer in the distribution of existence probability, as a mobile area in which a mobile object without a predetermined moving route, of the at least one mobile object, moves.

5. The area management system according to claim 4, wherein the mobile objects without a predetermined moving route include a person and an autonomous mobile robot (AMR).

6. The area management system according to claim 1, wherein the area definition unit is configured to define an area partially or entirely surrounded by points at which continuity of the distribution of existence probability is interrupted, as a work area in which a predetermined work is conducted by the at least one mobile object.

7. The area management system according to claim 1, further comprising a database in which a plurality of types of the distribution of existence probability and a plurality of area attributes are stored in association with each other, wherein:
the area definition unit is configured to define at least part of the distribution of existence probability, generated by the statistical processing unit, as the predetermined area and extract, from the database, the area attribute associated with the distribution of existence probability of the type corresponding to the at least part of the distribution of existence probability, generated by the statistical processing unit; and
the area definition unit is configured to define the extracted area attribute as an area attribute of the at least part of the distribution of existence probability, generated by the statistical processing unit.

8. The area management system according to claim 1, wherein the area definition unit is configured to be capable of identifying a location at which, in the predetermined area defined as a mobile area in which the at least one mobile object moves, an existence probability at a scheduled existence location of the at least one mobile object after a lapse of a predetermined period of time is lower than or equal to a predetermined probability.

9. An area management method comprising:
acquiring information on a mobile history of at least one mobile object that moves in a management target area;
generating a distribution of existence probability of the at least one mobile object in the management target area by performing statistical processing on the acquired information on the mobile history of the at least one mobile object; and
defining a predetermined area included in the management target area together with an area attribute of the predetermined area, based on the generated distribution of existence probability of the at least one mobile object in the management target area.

10. A non-transitory storage medium storing an area management program causing a computer to execute functions, the functions comprising:
acquiring information on a mobile history of at least one mobile object that moves in a management target area;
generating a distribution of existence probability of the at least one mobile object in the management target area by performing statistical processing on the acquired information on the mobile history of the at least one mobile object; and
defining a predetermined area included in the management target area together with an area attribute of the predetermined area, based on the generated distribution of existence probability of the at least one mobile object in the management target area.
